(19) United States
(12) Patent Application Publication
(10) Pub. No.: US 2021/0333869 A1
(43) Pub. Date: Oct. 28, 2021

(54) VEHICLE CONTROL DEVICE AND VEHICLE CONTROL METHOD

(71) Applicant: LG ELECTRONICS INC., Seoul (KR)

(72) Inventors: Jaehoon CHO, Seoul (KR); Doyun PARK, Seoul (KR); Joohyeon OH, Seoul (KR); Dongkyu LEE, Seoul (KR); Heejeong HEO, Seoul (KR)

(73) Assignee: LG ELECTRONICS INC., Seoul (KR)

(21) Appl. No.: 16/483,158

(22) PCT Filed: Nov. 30, 2018
(86) PCT No.: PCT/KR2018/015148

§ 371 Date: Aug. 2, 2019

(51) Int. Cl. G06F 3/01; B60K 35/00; G06F 3/16; G06F 3/0488; H04R 1/08

(52) U.S. Cl. CPC G06F 3/013; B60K 35/00; G06F 3/017; G06F 3/167; G06F 3/0488; H04R 1/08; H04R 2499/13; B60K 2370/1438; B60K 2370/146; B60K 2370/21; B60K 2370/73; B60K 2370/157; B60K 2370/148

(57) ABSTRACT

Disclosed herein is a control method. The control method includes monitoring a gaze of an occupant present inside a vehicle through a camera, receiving a control command from the occupant through an input unit, determining a control target on the basis of a result of monitoring the gaze of the occupant and the control command, and controlling the control target on the basis of the control command.

### TECHNICAL FIELD

The present invention relates to a vehicle control device and a vehicle control method.

### BACKGROUND ART

Vehicles may be classified as internal combustion engine vehicles, external combustion engine vehicles, gas turbine vehicles, electric vehicles, and the like, according to types of prime movers used therein.

Recently, for the safety and convenience of drivers and pedestrians, smart vehicles have been actively developed and research into sensors to be mounted on the intelligent vehicles have actively been conducted. Cameras, infrared sensors, radars, global positioning systems (GPS), lidars, and gyroscopes are used in intelligent vehicles, among which cameras serve to substitute for human eyes.

Due to development of various sensors and electronic equipment, vehicles equipped with a driving assistance function of assisting an occupant in driving and improving driving safety and convenience has come to prominence.

### DISCLOSURE

### Technical Problem

An embodiment of the present invention provides a control device for assisting driving of a vehicle.

Furthermore, an embodiment of the present invention provides a control device capable of controlling inside and outside of a vehicle according to an utterance, a gaze, a manual gesture, and the like, of an occupant.

Furthermore, an embodiment of the present invention provides a control device capable of providing a control function suitable for each occupant when a plurality of inputs are received from a plurality of occupants.

Furthermore, an embodiment of the present invention provides a method of assisting driving of a vehicle.

Furthermore, an embodiment of the present invention provides a control method of controlling inside and the outside of a vehicle according to an utterance, a gaze, a manual gesture, and the like, of an occupant.

Furthermore, an embodiment of the present invention provides a control method capable of providing a control function suitable for each occupant when a plurality of inputs are received from a plurality of occupants.

### Technical Solution

Furthermore, in this specification, a control method includes: monitoring a gaze of an occupant present inside a vehicle through a camera; receiving a control command from the occupant through an input unit; determining a control target on the basis of a result of monitoring the gaze of the occupant and the control command; and controlling the control target on the basis of the control command.

The determining of a control target may include: searching for a plurality of control targets on the basis of the result of monitoring of the gaze of the occupant; and specifying one of the plurality of control targets on the basis of the control command from the occupant.

The control method may further include: continuing to monitor the gaze of the occupant if the control target is determined.

In the control method, if the control target is determined, the control target may be controlled regardless of the result of monitoring of the gaze of the occupant.

The input unit may be a microphone installed inside the vehicle, and the control method may further include receiving an utterance of the occupant through the microphone.

The control method may further include: lowering a weight of the result of monitoring of the gaze of the occupant and raising a weight of the utterance of the occupant received through the microphone if the control target is controlled on the basis of the control command.

The input unit may be the camera, and the control method may further include: receiving a touch input or a gesture input of the occupant as the control command through the camera, wherein the determining of the control target may include determining the control target on the basis of at least one of the touch input or the gesture input of the occupant and the result of monitoring of the gaze of the occupant.

The input unit may include the camera and a microphone installed in the vehicle, and the control method may further include: receiving an utterance of the occupant as a first control command through the microphone; receiving a touch input or a gesture input of the occupant as a second control command through the camera; and determining the control target on the basis of the first control command and the second control command if accuracy of the result of monitoring of the gaze of the occupant is equal to or less than a reference value.

The control method may further include: providing feedback to the occupant through a feedback unit installed inside the vehicle and including a reference region.

The control method may further include: rotating the feedback unit such that the reference region faces the control target when the control target is determined.

The control method may further include: rotating the feedback unit such that the reference region faces the occupant when controlling of the control target is completed.

The occupant may include: a first occupant and a second occupant, and the control method may further include: rotating the feedback unit such that the reference region faces the second occupant when the control command is received from the second occupant.

The control method may further include: displaying an image related to the control target on a display unit inside the vehicle when the control target is determined.

The control method may further include: displaying an image related to the control target on the display unit of the vehicle when the control target is controlled.

The control method may further include: when the control target is determined as a display unit inside the vehicle and the result of monitoring of the gaze of the occupant is a first region of the display unit, displaying an image in the first region on the basis of the control command.

The control method may further include: monitoring a gaze of the occupant, after displaying the image in the first region, to obtain a second monitoring result; receiving a second control command from the occupant; and displaying an image in a second region of the display unit on the basis of the second control command when a second control target is determined as the second region on the basis of the second monitoring result and the second control command.

The control method may further include: providing feedback to the occupant through a sound output unit installed inside the vehicle.

Furthermore, in this specification, a control device includes: an interface unit connected to a camera for monitoring a gaze of an occupant and an input unit receiving a control command from the occupant; and a processor exchanging information with the camera and the input unit through the interface unit, wherein the processor determines a control target on the basis of a result of monitoring the gaze of the occupant and the control command and controls the control target on the basis of the control command.

The processor may search for a plurality of control targets on the basis of the result of monitoring of the gaze of the occupant and specify one of the plurality of control targets on the basis of the control command of the occupant.

The processor may continue monitoring the gaze of the occupant if the control target is specified.

The processor may control the control target regardless of the result of monitoring of the gaze of the occupant, when the control target is determined.

### Advantageous Effects

Effects of the control device according to the present invention are as follows.

According to at least one of the embodiments of the present invention, the control device assisting driving of a vehicle can be provided.

According to at least one of the embodiments of the present invention, the control device capable of controlling inside and outside of a vehicle according to an utterance, a gaze, a manual gesture, and the like, of an occupant can be provided.

According to at least one of the embodiments of the present invention, the control device capable of providing a control function suitable for each occupant when a plurality of inputs are received from a plurality of occupants can be provided.

Effects of the control method according to the present invention are as follows.

According to at least one of the embodiments of the present invention, the method of assisting driving of a vehicle can be provided.

According to at least one of the embodiments of the present invention, the control method of controlling inside and the outside of a vehicle according to an utterance, a gaze, a manual gesture, and the like, of an occupant can be provided.

According to at least one of the embodiments of the present invention, when there is a plurality of inputs from a plurality of occupants, the control method capable of providing a control function suitable for each occupant when a plurality of inputs are received from a plurality of occupants can be provided.

### DESCRIPTION OF DRAWINGS

FIG. 1 shows an appearance of a vehicle including a control device according to an embodiment of the present invention.

FIG. 2 is an example of an internal block diagram of a vehicle.

FIG. 3 is a block diagram of a control device according to an embodiment of the present invention.

FIG. 4 is a plan view of a vehicle including a control device according to an embodiment of the present invention.

FIG. 5 shows an example of a camera according to an embodiment of the present invention.

FIG. 6 is a view showing the inside of a vehicle having a vehicle driving assistance apparatus according to an embodiment of the present invention.

FIGS. 7 to 24 are views showing a control device according to an embodiment of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle as described in this specification may include a vehicle and a motorcycle. Hereinafter, a vehicle will be as an example of a vehicle.

A vehicle as described in this specification may include all of an internal combustion engine vehicle including an engine as a power source, a hybrid vehicle including both an engine and an electric motor as a power source, and an electric vehicle including an electric motor as a power source.

In some implementations, the left of a vehicle means the left of the vehicle in the direction of travel and the right of the vehicle means the right of the vehicle in the direction of travel.

In some implementations, a left hand drive (LHD) vehicle will be assumed unless otherwise stated.

Hereinafter, a user, a driver, an occupant, and a fellow occupant may be mixed according to an embodiment.

In the following description, a control device 100, a separate device provided in a vehicle, executes a vehicle driving assistance function, while exchanging necessary information with the vehicle through data communication. However, an aggregation of some of the units of the vehicle may also be defined as the control device 100. The control device 100 may also be referred to as a vehicle control device 100, a vehicle driving assistance device 100, or a driving assistance device 100.

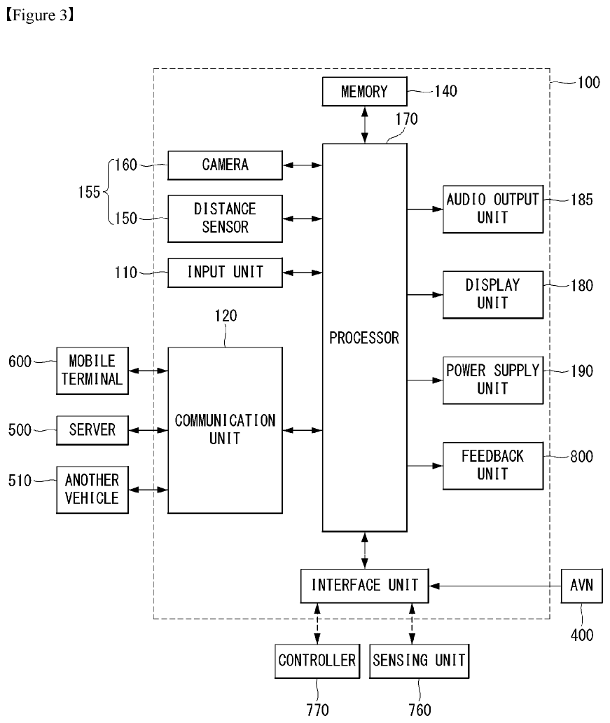

When the control device 100 is a separate device, at least some of the units (see FIG. 3) of the control device 100 may not be included in the control device 100 and may be a unit of the vehicle or another device mounted in the vehicle. The external units may be understood as being included in the control device 100 by transmitting and receiving data through an interface unit of the control device 100.

For the purposes of description, the control device 100 according to an embodiment will be described as directly including the units shown in FIG. 3.

Hereinafter, the control device 100 according to an embodiment will be described in detail with reference to the drawings.

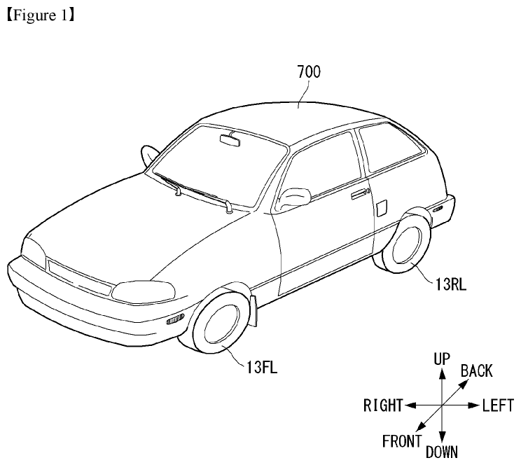

Referring to FIG. 1, a vehicle according to an embodiment may include wheels 13FL and 13RL rotated by a power source and the control device 100 providing driving assistance information to a user.

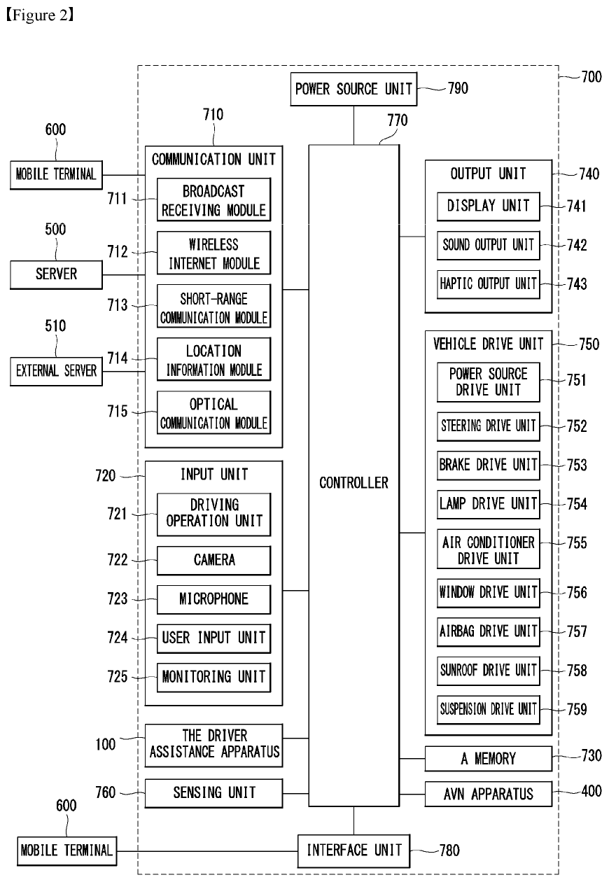

Referring to FIG. 2, the vehicle may include the communication unit 710, the input unit 720, the sensing unit 760, an output unit 740, a vehicle drive unit 750, a memory 730, an interface unit 780, the controller 770, the power source unit 790, the driver assistance apparatus 100, and the AVN apparatus 400. The communication unit 710 may include one or more modules to enable the wireless communication between the vehicle 700 and the mobile terminal 600, between the vehicle 700 and the external server 510, or between the vehicle 700 and another vehicle. In addition, the communication unit 710 may include one or more modules to connect the vehicle 700 to one or more networks.

The communication unit 710 may include a broadcast receiving module 711, a wireless Internet module 712, a short-range communication module 713, a location information module 714, and an optical communication module 715.

The broadcast receiving module 711 is configured to receive a broadcast signal or broadcast associated information from an external broadcast managing server via a broadcast channel. Here, broadcast includes radio broadcast or TV broadcast.

The wireless Internet module 712 is a module for wireless Internet access. The wireless Internet module 712 may be internally or externally coupled to the vehicle 700. The wireless Internet module 712 may transmit or receive wireless signals via communication networks according to wireless Internet technologies.

Examples of such wireless Internet technologies include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), and LTE-A (Long Term Evolution-Advanced). The wireless Internet module 712 may transmit and receive data according to one or more of such wireless Internet technologies, and other Internet technologies as well. For example, the wireless Internet module 712 may exchange data with the external server 510 in a wireless manner. The wireless Internet module 712 may receive weather information and road traffic state information (e.g., Transport Protocol Expert Group (TPEG) information) from the external server 510.

The short-range communication module 713 may assist short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication module 713 forms wireless area networks to perform the short-range communication between the vehicle 700 and at least one external device. For example, the short-range communication module 713 may exchange data with the mobile terminal 600 in a wireless manner. The short-range communication module 713 may receive weather information and road traffic state information (e.g., Transport Protocol Expert Group (TPEG) information) from the mobile terminal 600. When the user gets into the vehicle 700, the mobile terminal 600 of the user and the vehicle 700 may pair with each other automatically or as the user executes a pairing application.

The location information module 714 is a module to acquire a location of the vehicle 700. A representative example of the location information module 714 includes a Global Position System (GPS) module. For example, when the vehicle utilizes a GPS module, a location of the vehicle may be acquired using signals transmitted from GPS satellites.

The optical communication module 715 may include a light emitting unit and a light receiving unit.

The light receiving unit may convert light into electrical signals to receive information. The light receiving unit may include Photo Diodes (PDPs) to receive light. The photo diodes may convert light into electrical signals. For example, the light receiving unit may receive information regarding a preceding vehicle via light emitted from a light source included in the preceding vehicle.

The light emitting unit may include at least one light emitting element to convert electrical signals into light. Here, the light emitting element may be a Light Emitting Diode (LED). The light emitting unit converts electrical signals into light to thereby emit the light. For example, the light emitting unit may externally emit light via flickering of the light emitting element corresponding to a prescribed frequency. In some embodiments, the light emitting unit may include an array of a plurality of light emitting elements. In some embodiments, the light emitting unit may be integrated with a lamp provided in the vehicle 700. For example, the light emitting unit may be at least one selected from among a headlight, a taillight, a brake light, a turn signal light, and a sidelight. For example, the optical communication module 715 may exchange data with another vehicle 520 via optical communication.

The input unit 720 may include a driving operation unit 721, the camera 722, a microphone 723, and the user input unit 724.

The driving operation unit 721 is configured to receive user input for the driving of the vehicle 700. The driving operation unit 721 may include the steering input unit 721a, a shift input unit 721b, an acceleration input unit 721c, and a brake input unit 721d.

The steering input unit 721a is configured to receive user input with regard to the direction of travel of the vehicle 700. The steering input unit 721a may take the form of the steering wheel 12 as illustrated in FIG. 1. In some embodiments, the steering input unit 721a may be configured as a touchscreen, a touch pad, or a button.

The shift input unit 721b is configured to receive input for selecting one of Park (P), Drive (D), Neutral (N) and Reverse (R) gears of the vehicle 700 from the user. The shift input unit 721b may have a lever form. In some embodiments, the shift input unit 721b may be configured as a touchscreen, a touch pad, or a button.

The acceleration input unit 721c is configured to receive user input for the acceleration of the vehicle 700. The brake input unit 721d is configured to receive user input for the speed reduction of the vehicle 700. Each of the acceleration input unit 721c and the brake input unit 721d may have a pedal form. In some embodiments, the acceleration input unit 721c or the brake input unit 721d may be configured as a touchscreen, a touch pad, or a button.

The camera 722 may include an image sensor and an image processing module. The camera 722 may process a still image or a moving image acquired by the image sensor (e.g., a CMOS or a CCD). The image processing module may extract required information by processing a still image or a moving image acquired via the image sensor and, then, may transmit the extracted information to the controller 770. Meanwhile, the vehicle 700 may include the camera 722 to capture a forward image or a surround-view image of the vehicle and an monitoring unit 725 to capture an image of the inside of the vehicle.

The monitoring unit 725 may capture an image of an occupant. The monitoring unit 725 may capture an image of biometrics of the occupant.

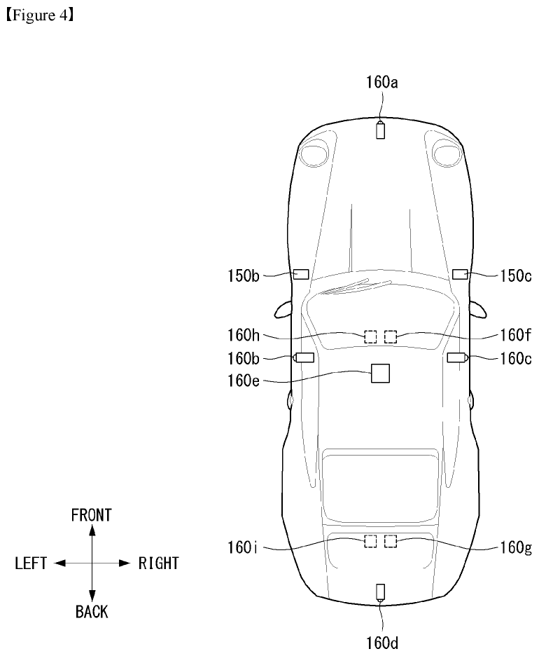

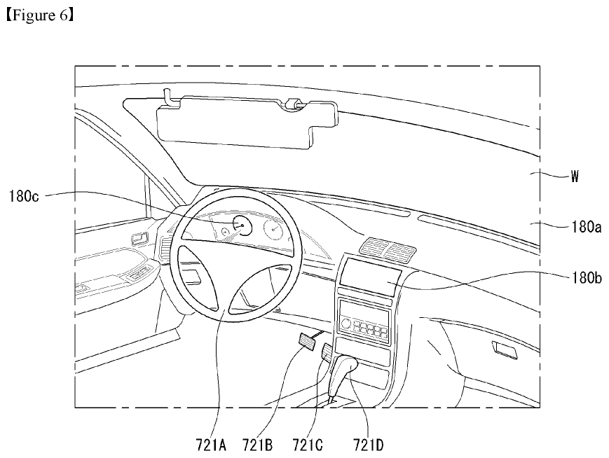

Meanwhile, although FIG. 2 illustrates the camera 722 as being included in the input unit 720, the camera 722 may be described as being a component of the driver assistance apparatus 100 as described above with reference to FIGS. 2 to 6.

The microphone 723 may process external sound signals into electrical data. The processed data may be utilized in various ways according to a function that the vehicle 700 is performing. The microphone 723 may convert a user voice command into electrical data.

The converted electrical data may be transmitted to the controller 770.

Meanwhile, in some embodiments, the camera 722 or the microphone 723 may be components of the sensing unit 760, other than components of the input unit 720.

The user input unit 724 is configured to receive information from the user. When information is input via the user input unit 724, the controller 770 may control the operation of the vehicle 700 to correspond to the input information. The user input unit 724 may include a touch input unit or a mechanical input unit. In some embodiments, the user input unit 724 may be located in a region of the steering wheel. In this case, the driver may operate the user input unit 724 with the fingers while gripping the steering wheel.

The sensing unit 760 is configured to detect signals associated with, for example, the traveling of the vehicle 700. To this end, the sensing unit 760 may include a collision sensor, a steering sensor, a speed sensor, gradient sensor, a weight sensor, a heading sensor, a yaw sensor, a gyro sensor, a position module, a vehicle forward/backward movement sensor, a battery sensor, a fuel sensor, a tire sensor, a steering sensor on the basis of the rotation of a steering wheel, a vehicle inside temperature sensor, a vehicle inside humidity sensor, an ultrasonic sensor, an infrared sensor, a radar, and Lidar.

As such, the sensing unit 760 may acquire sensing signals with regard to, for example, vehicle collision information, vehicle traveling direction information, vehicle location information (GPS information), vehicle angle information, vehicle speed information, vehicle acceleration information, vehicle tilt information, vehicle forward/backward movement information, battery information, fuel information, tire information, vehicle lamp information, vehicle inside temperature information, vehicle inside humidity information, and steering wheel rotation angle information. In addition, the driver assistance apparatus 100 that will be described below may generate control signals for acceleration, speed reduction, direction change and the like of the vehicle 700 on the basis of surrounding environment information acquired by at least one of the camera, the ultrasonic sensor, the infrared sensor, the radar, and Lidar included in the vehicle 700. Here, the surrounding environment information may be information related to various objects located within a prescribed distance range from the vehicle 700 that is traveling. For example, the surrounding environment information may include the number of obstacles located within a distance of 100 m from the vehicle 700, the distances to the obstacles, the sizes of the obstacles, the kinds of the obstacles, and the like.

Meanwhile, the sensing unit 760 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 760 may include a biometric information sensing unit. The biometric information sensing unit is configured to detect and acquire biometric information of the occupant. The biometric information may include fingerprint information, iris-scan information, retina-scan information, hand geometry information, facial recognition information, and voice recognition information. The biometric information sensing unit may include a sensor to detect biometric information of the occupant. Here, the monitoring unit 725 and the microphone 723 may operate as sensors. The biometric information sensing unit may acquire hand geometry information and facial recognition information via the monitoring unit 725.

The output unit 740 is configured to output information processed in the controller 770. The output unit 740 may include the display unit 741, a sound output unit 742, and a haptic output unit 743.

The display unit 741 may display information processed in the controller 770. For example, the display unit 741 may display vehicle associated information. Here, the vehicle associated information may include vehicle control information for the direct control of the vehicle or driver assistance information to guide vehicle driving. In addition, the vehicle associated information may include vehicle state information that notifies a current state of the vehicle or vehicle traveling information regarding the traveling of the vehicle.

The display unit 741 may include at least one selected from among a Liquid Crystal Display (LCD), a Thin Film Transistor LCD (TFT LCD), an Organic Light Emitting Diode (OLED), a flexible display, a 3D display, and an e-ink display.

The display unit 741 may configure an inter-layer structure with a touch sensor, or may be integrally formed with the touch sensor to implement a touchscreen. The touchscreen may function as the user input unit 724 which provides an input interface between the vehicle 700 and the user and also function to provide an output interface between the vehicle 700 and the user. In this case, the display unit 741 may include a touch sensor which senses a touch to the display unit 741 so as to receive a control command in a touch manner.

When a touch is input to the display unit 741 as described above, the touch sensor may detect the touch and the controller 770 may generate a control command corresponding to the touch. Content input in a touch manner may be characters or numbers, or may be, for example, instructions in various modes or menu items that may be designated.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like. Hereinafter, a touch or a touch input may generally refer to various types of touches mentioned above.

Meanwhile, the display unit 741 may include a cluster to allow the driver to check vehicle state information or vehicle traveling information while driving the vehicle. The cluster may be located on a dashboard. In this case, the driver may check information displayed on the cluster while looking forward.

Meanwhile, in some embodiments, the display unit 741 may be implemented as a Head Up display (HUD). When the display unit 741 is implemented as a HUD, information may be output via a transparent display provided at the windshield. Alternatively, the display unit 741 may include a projector module to output information via an image projected to the windshield.

The sound output unit 742 is configured to convert electrical signals from the controller 770 into audio signals and to output the audio signals. To this end, the sound output unit 742 may include, for example, a speaker. The sound output unit 742 may output sound corresponding to the operation of the user input unit 724.

The haptic output unit 743 is configured to generate tactile output. For example, the haptic output unit 743 may operate to vibrate a steering wheel, a safety belt, or a seat so as to allow the user to recognize an output thereof.

The vehicle drive unit 750 may control the operation of various devices of the vehicle. The vehicle drive unit 750 may include at least one of a power source drive unit 751, a steering drive unit 752, a brake drive unit 753, a lamp drive unit 754, an air conditioner drive unit 755, a window drive unit 756, an airbag drive unit 757, a sunroof drive unit 758, and a suspension drive unit 759.

The power source drive unit 751 may perform electronic control for a power source inside the vehicle 700. The power source drive unit 751 may include an acceleration device to increase the speed of the vehicle 700 and a speed reduction device to reduce the speed of the vehicle 700.

For example, in the case where a fossil fuel based engine (not illustrated) is a power source, the power source drive unit 751 may perform electronic control for the engine. As such, the power source drive unit 751 may control, for example, an output torque of the engine. In the case where the power source drive unit 751 is the engine, the power source drive unit 751 may control the speed of the vehicle by controlling the output torque of the engine under the control of the controller 770.

In another example, when an electric motor (not illustrated) is a power source, the power source drive unit 751 may perform control for the motor. As such, the power source drive unit 751 may control, for example, the RPM and torque of the motor.

The steering drive unit 752 may include a steering apparatus. Thus, the steering drive unit 752 may perform electronic control for a steering apparatus inside the vehicle 700.

The brake drive unit 753 may perform electronic control of a brake apparatus (not illustrated) inside the vehicle 700. For example, the brake drive unit 753 may reduce the speed of the vehicle 700 by controlling the operation of brakes located at wheels. In another example, the brake drive unit 753 may adjust the direction of travel of the vehicle 700 leftward or rightward by differentiating the operation of respective brakes located at left and right wheels.

The lamp drive unit 754 may turn at least one lamp arranged inside and outside the vehicle 700 on or off. The lamp drive unit 754 may include a lighting apparatus. In addition, the lamp drive unit 754 may control, for example, the intensity and direction of light of each lamp included in the lighting apparatus. For example, the lamp drive unit 754 may perform control for a turn signal lamp, a headlamp or a brake lamp.

The air conditioner drive unit 755 may perform the electronic control of an air conditioner (not illustrated) inside the vehicle 700. For example, when the inside temperature of the vehicle 700 is high, the air conditioner drive unit 755 may operate the air conditioner to supply cold air to the inside of the vehicle 700.

The window drive unit 756 may perform the electronic control of a window apparatus inside the vehicle 700. For example, the window drive unit 756 may control the opening or closing of left and right windows of the vehicle 700.

The airbag drive unit 757 may perform the electronic control of an airbag apparatus inside the vehicle 700. For example, the airbag drive unit 757 may control an airbag to be deployed in a dangerous situation.

The sunroof drive unit 758 may perform electronic control of a sunroof apparatus inside the vehicle 700. For example, the sunroof drive unit 758 may control the opening or closing of a sunroof.

The suspension drive unit 759 may perform electronic control on a suspension apparatus (not shown). For example, when a road surface has a curve, the suspension drive unit 759 may control the suspension apparatus to reduce vibrations of a vehicle.

The memory 730 is electrically connected to the controller 770. The memory 730 may store basic data for each unit, control data for the operation control of the unit, and input/output data. The memory 730 may be various hardware storage devices such as, for example, a ROM, a RAM, an EPROM, a flash drive, and a hard drive. The memory 730 may store various data for the overall operation of the vehicle 700 such as, for example programs for the processing or control of the controller 770.

The interface unit 780 may serve as a passage for various kinds of external devices that are connected to the vehicle 700. For example, the interface unit 780 may have a port that is connectable to the mobile terminal 600 and may be connected to the mobile terminal 600 via the port. In this case, the interface unit 780 may exchange data with the mobile terminal 600.

Meanwhile, the interface unit 780 may serve as a passage for the supply of electrical energy to the connected mobile terminal 600. When the mobile terminal 600 is electrically connected to the interface unit 780, the interface unit 780 supplies electrical energy from the power source unit 790 to the mobile terminal 600 under the control of the controller 770.

The controller 770 may control the overall operation of each unit inside the vehicle 700. The controller 770 may be referred to as an Electronic Control Unit (ECU).

The controller 770 may execute a function corresponding to an execution signal delivered from the control device 100.

The controller 770 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The controller 770 may play the role of the processor 170 described above. That is, the processor 170 of the control device 100 may directly set in the controller 770 of the vehicle. In this embodiment, the control device 100 may be understood to designate a combination of some components of the vehicle.

Further, the controller 770 may control components to transmit information requested by the processor 170.

The power source unit 790 may supply power required to operate the respective components under the control of the controller 770. In particular, the power source unit 790 may receive power from, for example, a battery (not illustrated) inside the vehicle 700.

The AVN apparatus 400 may exchange data with the controller 770. The controller 770 may receive navigation information from the AVN apparatus 400 or a separate navigation apparatus (not illustrated). Here, the navigation information may include set destination information, destination based routing information, and map information or vehicle location information related to vehicle traveling.

Referring to FIG. 3, the vehicle control device 100 may include an input unit 110, a communication unit 120, an interface 130, a sensor unit 155, a monitoring unit 165, a processor 170, a display unit 180, an audio output unit 185, and a power supply unit 190. However, the units of the vehicle control device 100 of FIG. 3 are unnecessary to realize the vehicle control device 100. Thus, the vehicle control device 100 described in this specification may include additional components in addition to the above-described components, or a portion of the above-described components may be omitted.

Each component will now be described in detail. The vehicle control device 100 may include the input unit 110 for receiving user input.

For example, a user may input setting/execution of the vehicle surrounding image display function and the self-driving function, which are provided by the vehicle control device 100, or may input execution of power on/off of the vehicle control device 100 through the input unit 110.

The input unit 110 may include at least one of a gesture input unit (e.g., an optical sensor, etc.) for sensing a user gesture, a touch input unit (e.g., a touch sensor, a touch key, a push key (mechanical key), etc.) for sensing touch and a microphone for sensing voice input and receive user input.

Next, the vehicle control device 100 may include the communication unit 120 for communicating with another vehicle 510, a terminal 600 and a server 500.

The communication unit 120 may receive changed information in outer appearance of the vehicle or vehicle surrounding information from an object mounted on the outside of the vehicle or a structure for mounting the object. Also, the vehicle control device 100 may display the vehicle surrounding image on the basis of the changed information in outer appearance of the vehicle and the vehicle surrounding information and provide the self-driving function.

In detail, the communication unit 120 may receive at least one of position information, weather information and road traffic condition information (e.g., transport protocol experts group (TPEG), etc.) from the mobile terminal 600 and/or the server 500.

The communication unit 120 may receive traffic information from the server 500 having an intelligent traffic system (ITS). Here, the traffic information may include traffic signal information, lane information, vehicle surrounding information or position information.

In addition, the communication unit 120 may receive navigation information from the server 500 and/or the mobile terminal 600. Here, the navigation information may include at least one of map information related to vehicle driving, lane information, vehicle position information, set destination information and route information according to the destination.

For example, the communication unit 120 may receive the real-time position of the vehicle as the navigation information. In detail, the communication unit 120 may include a global positioning system (GPS) module and/or a Wi-Fi (Wireless Fidelity) module and acquire the position of the vehicle.

In addition, the communication unit 120 may receive driving information of the other vehicle 510 from the other vehicle 510 and transmit information on this vehicle, thereby sharing driving information between vehicles. Here, the shared driving information may include vehicle traveling direction information, position information, vehicle speed information, acceleration information, moving route information, forward/reverse information, adjacent vehicle information and turn signal information.

In addition, when a user rides in the vehicle, the mobile terminal 600 of the user and the vehicle control device 100 may pair with each other automatically or by executing a user application.

The communication unit 120 may exchange data with the other vehicle 510, the mobile terminal 600 or the server 500 in a wireless manner.

In detail, the communication unit 120 may perform wireless communication using a wireless data communication method. As the wireless data communication method, technical standards or communication methods for mobile communications (for example, Global System for Mobile Communication (GSM), Code Division Multiple Access (CDMA), CDMA2000 (Code Division Multiple Access 2000), EV-DO (Evolution-Data Optimized), Wideband CDMA (WCDMA), High Speed Downlink Packet Access (HSDPA), HSUPA (High Speed Uplink Packet Access), Long Term Evolution (LTE), LTE-A (Long Term Evolution-Advanced), and the like) may be used.

The communication unit 120 is configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

In addition, the communication unit 120 is configured to facilitate short-range communication. For example, short-range communication may be supported using at least one of Bluetooth™, Radio Frequency IDentification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In addition, the vehicle control device 100 may pair with the mobile terminal located inside the vehicle using a short-range communication method and wirelessly exchange data with the other vehicle 510 or the server 500 using a long-distance wireless communication module of the mobile terminal.

Next, the vehicle control device 100 may include the interface 130 for receiving data of the vehicle and transmitting a signal processed or generated by the processor 170.

In detail, the vehicle control device 100 may receive at least one of driving information of another vehicle, navigation information and sensor information via the interface 130.

In addition, the vehicle control device 100 may transmit a control signal for executing a driving assistance function or information generated by the vehicle control device 100 to the controller 770 of the vehicle via the interface 130.

To this end, the interface 130 may perform data communication with at least one of the controller 770 of the vehicle, an audio-video-navigation (AVN) apparatus 400 and the sensing unit 760 using a wired or wireless communication method.

In detail, the interface 130 may receive navigation information by data communication with the controller 770, the AVN apparatus 400 and/or a separate navigation apparatus.

In addition, the interface 130 may receive sensor information from the controller 770 or the sensing unit 760.

Here, the sensor information may include at least one of vehicle traveling direction information, vehicle position information, vehicle speed information, acceleration information, vehicle tilt information, forward/reverse information, fuel information, information on a distance from a preceding/rear vehicle, information on a distance between a vehicle and a lane and turn signal information, etc.

The sensor information may be acquired from a heading sensor, a yaw sensor, a gyro sensor, a position module, a vehicle forward/reverse sensor, a wheel sensor, a vehicle speed sensor, a vehicle tilt sensor, a battery sensor, a fuel sensor, a tire sensor, a steering sensor on the basis of rotation of the steering wheel, a vehicle inside temperature sensor, a vehicle inside humidity sensor, a door sensor, etc. The position module may include a GPS module for receiving GPS information.

The interface 130 may receive user input via the user input unit 110 of the vehicle. The interface 130 may receive user input from the input unit of the vehicle or via the controller 770. That is, when the input unit is provided in the vehicle, user input may be received via the interface 130.

In addition, the interface 130 may receive traffic information acquired from the server. The server 500 may be located at a traffic control surveillance center for controlling traffic. For example, when traffic information is received from the server 500 via the communication unit 120 of the vehicle, the interface 130 may receive traffic information from the controller 770.

Next, the memory 140 may store a variety of data for overall operation of the vehicle control device 100, such as a program for processing or control of the controller 170.

In addition, the memory 140 may store data and commands for operation of the vehicle control device 100 and a plurality of application programs or applications executed in the vehicle control device 100. At least some of such application programs may be downloaded from an external server through wireless communication. At least one of such application programs may be installed in the vehicle control device 100 upon release, in order to provide the basic function (e.g., the driver assistance information guide function) of the vehicle control device 100.

Such application programs may be stored in the memory 140 and may be executed to perform operation (or function) of the vehicle control device 100 by the processor 170.

The memory 140 may store data for checking an object included in an image. For example, the memory 140 may store data for checking a predetermined object using a predetermined algorithm when the predetermined object is detected from an image of the vicinity of the vehicle acquired through the camera 160.

For example, the memory 140 may store data for checking the object using the predetermined algorithm when the predetermined algorithm such as a lane, a traffic sign, a two-wheeled vehicle and a pedestrian is included in an image acquired through the camera 160.

The memory 140 may be implemented in a hardware manner using at least one selected from among a flash memory, a hard disk, a solid state drive (SSD), a silicon disk drive (SDD), a micro multimedia vehicled, a vehicled type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disc.

In addition, the vehicle control device 100 may operate in association with a network storage for performing a storage function of the memory 140 over the Internet.

Next, the monitoring unit 165 may acquire information on the internal state of the vehicle.

The information detected by the monitoring unit may include at least one of facial recognition information, fingerprint information, iris-scan information, retina-scan information, hand geo-metry information, and voice recognition information. The monitoring unit may include other sensors for sensing such biometric recognition information.

Next, the vehicle control device 100 may further include the sensor unit 155 for sensing objects located in the vicinity of the vehicle. The vehicle control device 100 may include the sensor unit 155 for sensing peripheral objects and may receive the sensor information obtained by the sensor unit 155 of the vehicle via the interface 130. The acquired sensor information may be included in the information on the vehicle surrounding information.

The sensor unit 155 may include at least one of a distance sensor 150 for sensing the position of an object located in the vicinity of the vehicle and a camera 160 for capturing the image of the vicinity of the vehicle.

First, the distance sensor 150 may accurately detect the position of the object located in the vicinity of the vehicle, a distance between the object and the vehicle, a movement direction of the object, etc. The distance sensor 150 may continuously measure the position of the sensed object to accurately detect change in positional relationship with the vehicle.

The distance sensor 150 may detect the object located in at least one of the front, rear, left and right areas of the vehicle. The distance sensor 150 may be provided at various positions of the vehicle.

FIG. 3 illustrates an example exterior of a vehicle including an example vehicle control device. Referring to FIG. 3, the distance sensor 150 may be provided at at least one of the front, rear, left and right sides and ceiling of the vehicle.

The distance sensor 150 may include at least one of various distance measurement sensors such as a Lidar sensor, a laser sensor, an ultrasonic wave sensor and a stereo camera.

For example, the distance sensor 150 is a laser sensor and may accurately measure a positional relationship between the vehicle and the object using a time-of-flight (TOF) and/or a phase-shift method according to a laser signal modulation method.

Information on the object may be acquired by analyzing the image captured by the camera 160 at the processor 170.

In detail, the vehicle control device 100 may capture the image of the vicinity of the vehicle using the camera 160, analyze the image of the vicinity of the vehicle using the processor 170, detect the object located in the vicinity of the vehicle, determine the attributes of the object and generate sensor information.

The image information is at least one of the type of the object, traffic signal information indicated by the object, the distance between the object and the vehicle and the position of the object and may be included in the sensor information.

In detail, the processor 170 may detect the object from the captured image via image processing, track the object, measure the distance from the object, and check the object to analyze the object, thereby generating image information.

The camera 160 may be provided at various positions.

In detail, the camera 160 may include an internal camera 160f for capturing an image of the front side of the vehicle within the vehicle and acquiring a front image.

Referring to FIG. 3, a plurality of cameras 160 may be provided at least one of the front, rear, right and left and ceiling of the vehicle.

In detail, the left camera 160b may be provided inside a case surrounding a left side view mirror. Alternatively, the left camera 160b may be provided outside the case surrounding the left side view mirror. Alternatively, the left camera 160b may be provided in one of a left front door, a left rear door or an outer area of a left fender.

The right camera 160c may be provided inside a case surrounding a right side view mirror. Alternatively, the right camera 160c may be provided outside the case surrounding the right side view mirror. Alternatively, the right camera 160c may be provided in one of a right front door, a right rear door or an outer area of a right fender.

In addition, the rear camera 160d may be provided in the vicinity of a rear license plate or a trunk switch. The front camera 160a may be provided in the vicinity of an emblem or a radiator grill.

The processor 170 may synthesize images captured in all directions and provide an around view image viewed from the top of the vehicle. Upon generating the around view image, boundary portions between the image regions occur. Such boundary portions may be subjected to image blending for natural display.

In addition, the ceiling camera 160e may be provided on the ceiling of the vehicle to capture the image of the vehicle in all directions.

The camera 160 may directly include an image sensor and an image processing module. The camera 160 may process a still image or a moving image obtained by the image sensor (e.g., CMOS or CCD). In addition, the image processing module processes the still image or the moving image acquired through the image sensor, extracts necessary image information, and delivers the extracted image information to the processor 170.

In order to enable the processor 170 to more easily perform object analysis, for example, the camera 160 may be a stereo camera for capturing an image and, at the same time, measuring a distance from an object.

The sensor unit 155 may be a stereo camera including the distance sensor 150 and the camera 160. That is, the stereo camera may acquire an image and, at the same time, detect a positional relationship with the object.

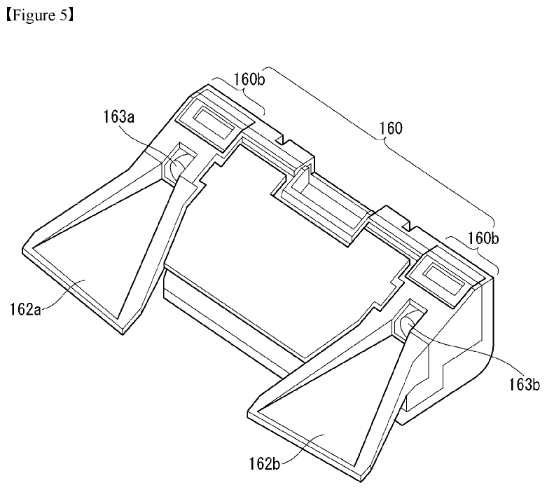

Referring to FIG. 5, the stereo camera 160 may include a first camera 160a having a first lens 163a and a second camera 160b having a second lens 163b.

Meanwhile, the vehicle driving assistance apparatus may further includes a first light shield 162a and a second light shield 162b for shielding light incident on the first lens 163a and the second lens 163b, respectively.

This vehicle driving assistance apparatus may obtain a stereo image of the surroundings of the vehicle from the first and second cameras 160a and 160b, perform disparity detection on the basis of the stereo image, detect an object from at least one stereo image on the basis of disparity information, and continue to track movement of the object after the object is detected.

Next, the control device 100 may further include a display unit 180 displaying a graphic image. The display unit 180 may include a plurality of displays. In detail, the display unit 180 may include a first display 180a for projecting and displaying a graphic image onto and on a vehicle windshield W. That is, the first display 180a is a head up display (HUD) and may include a projection module for projecting the graphic image onto the windshield W. The graphic image projected by the projection module may have predetermined transparency. Accordingly, a user may simultaneously view the front and rear sides of the graphic image.

The graphic image may overlap the image projected onto the windshield W to achieve augmented reality (AR).

The display unit may include a second display 180b separately provided inside the vehicle to display an image of the driving assistance function.

In detail, the second display 180b may be a display of a vehicle navigation apparatus or a center information display (CID). The third display 180c may be a cluster.

The second display 180b may include at least one selected from among a Liquid Crystal Display (LCD), a Thin Film Transistor LCD (TFT LCD), an Organic Light Emitting Diode (OLED), a flexible display, a 3D display, and an e-ink display.

The second display 180b and the third display 180c may be combined with a touch input unit to achieve a touch screen.

Next, the audio output unit 185 may audibly output a message for explaining the function of the vehicle display apparatus 100 and checking whether the driving assistance function is performed. That is, the vehicle display apparatus 100 may provide explanation of the function of the vehicle display apparatus 100 via visual display of the display unit 180 and audio output of the audio output unit 185.

Next, the haptic output unit may output an alarm for the driving assistance function in a haptic manner. For example, the vehicle display apparatus 100 may output vibration to the user when a warning is included in at least one of navigation information, traffic information, communication information, vehicle state information, advanced driver assistance system (ADAS) function and other driver convenience information.

The haptic output unit may provide directional vibration. For example, the haptic output unit may be provided in a steering apparatus for controlling steering to output vibration. Left or right vibration may be output according to the left and right sides of the steering apparatus to enable directional haptic output.

In addition, the power supply unit 190 may receive power and supply power necessary for operation of the components under control of the processor 170.

Lastly, the vehicle display apparatus 100 may include the processor 170 for controlling overall operation of the units of the vehicle display apparatus 100.

In addition, the processor 170 may control at least some of the components described with reference to FIG. 3 in order to execute the application program.

Further, the processor 170 may operate by combining at least two of the components included in the vehicle display apparatus 100, in order to execute the application program.

The processor 170 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, and electric units for the implementation of other functions.

The processor 170 may control overall operation of the vehicle display apparatus 100 in addition to operation related to the application programs stored in the memory 140. The processor 170 may process signals, data, information, etc. via the above-described components or execute the application programs stored in the memory 140 to provide appropriate information or functions to the user.

Traveling information includes a traveling mode of the vehicle 700, a state of the vehicle 700, a traveling state, a movement direction of the vehicle 700, a surrounding situation of the vehicle 700, an internal situation of the vehicle, and the like.

The traveling mode may be distinguished depending on whether driving of the vehicle 700 is manually performed by the driver, whether the driving of the vehicle 700 is automatically performed by the processor 170, or whether part of the driving of the vehicle 700 is performed manually by the driver and the other part thereof is performed automatically by the processor 170.

When an occupant 910 is located in the driver's seat S1, the occupant 910 may be referred to as a driver 910. When an occupant is located in the passenger's seat, the occupant may be referred to as a fellow occupant.

The processor 170 may monitor the inside of the vehicle 700 through a camera 160h installed inside the vehicle 700. In addition, the processor 170 may monitor the occupant 910 through the camera 160h installed inside the vehicle 700.

The processor 170 may monitor a gaze of the occupant 910 through the camera 160h. The processor 170 may monitor a direction of the gaze of the occupant 910 via the camera 160h.

The processor 170 may monitor an arm or a hand of the occupant 910 via the camera 160h. The processor 170 may monitor a direction of a fingertip or a finger of the occupant 910 through the camera 160h. The processor 170 may detect that the occupant 910 touches the inside of the vehicle 700. The processor 170 may detect a control target, a component, a portion of a component, or a plurality of components inside the vehicle 700 positioned in the direction indicated by the occupant 910. The processor 170 may detect a control target, a component, a portion of a component, or a plurality of components inside the vehicle 700 that the occupant 910 touches.

The control target may include all kinds of input units capable of performing a function of controlling the vehicle 700. For example, the control target may include a button, an image button, a control button, a dial, a jog, and the like, for controlling the vehicle 700.

The processor 170 may monitor the inside of the vehicle 700 through the camera 160h. The processor 170 may monitor the inside of the vehicle 700 positioned in the direction of the gaze of the occupant 910 through the camera 160h. The processor 170 may detect a control target, a component, a portion of a component, or a plurality of components inside the vehicle 700 positioned in the direction of the gaze of the occupant 910.

The processor 170 may receive an utterance of the occupant 910 through the microphone 110 installed inside the vehicle 700.

The processor 170 may determine a control target on the basis of the result of monitoring the gaze of the occupant 910 and the utterance of the occupant 910. The processor 170 may detect a plurality of control targets in a direction of the gaze of the occupant 910 by monitoring the gaze of the occupant 910 and may specify one of the plurality of control targets on the basis of the utterance of the occupant 910.

When the control target is determined or specified, the processor 170 may perform control on the basis of an utterance of the occupant 910. If the utterance of the occupant 910 is related to ON or OFF, the processor 170 may activate or deactivate the control target. When the control target is in an activated state, the processor 170 may deactivate the control target. When the control target is in a deactivated state, the processor 170 may activate the control target. Alternatively, when an utterance of the occupant 910 controls activation of the control target, the processor 170 may control activation of the control target on the basis of a control unit of the control target.

The processor 170 may determine the control target on the basis of a result of monitoring a direction indicated by the occupant 910 and the utterance of the occupant 910. The processor 170 may detect a plurality of control targets by monitoring the direction indicated by the occupant 910 and specify one of the plurality of control targets on the basis of the utterance of the occupant 910.

When the control target is determined or specified, the processor 170 may perform control on the basis of an utterance of the occupant 910. If the utterance of the occupant 910 is related to ON or OFF, the processor 170 may activate or deactivate the control target. When the control target is in an activated state, the processor 170 may deactivate the control target. When the control target is in a deactivated state, the processor 170 may activate the control target. Alternatively, when an utterance of the occupant 910 controls activation of the control target, the processor 170 may control activation of the control target on the basis of a control unit of the control target.

The processor 170 may determine a control target on the basis of a result of monitoring a gaze of the occupant 910 and a direction indicated by the occupant 910.

When a control target is determined or specified, the processor 170 may activate or deactivate the control target. When the control target is in an activated state, the processor 170 may deactivate the control target. When the control target is in a deactivated state, the processor 170 may activate the control target.

The processor 170 may determine a control target on the basis of a result of monitoring a gaze of the occupant 910 and a result of monitoring the occupant 910 touching the inside of the vehicle 700.

When a control target is determined or specified, the processor 170 may activate or deactivate the control target. When the control target is in an activated state, the processor 170 may deactivate the control target. When the control target is in a deactivated state, the processor 170 may activate the control target.

When a control target is specified, the processor 170 may display the specified control target through the display unit 180. In a case where an additional input is necessary to control the control target, the processor 170 may display an image requesting the additional input of the occupant 910 on the display unit 180. While controlling the control target, the processor 170 may display an image indicating that control is being performed. When control of the control target is completed, the processor 170 may display an image indicating that control is completed.

When a control target is specified, the processor 170 may output a sound indicating the specified control target through the audio output unit 185. In a case where an additional input is necessary to control the control target, the processor 170 may output a sound requesting the additional input of the occupant 910. While controlling the control target, the processor 170 may output a sound indicating that control is being performed. When control of the control target is completed, the processor 170 may output a sound indicating that control is completed.

The processor 170 may control the feedback unit 800. The feedback unit 800 may also be referred to as a feedback device 800, a robot 800, a feedback robot 800, or an agent 800. The feedback unit 800 may be installed inside the vehicle 700. The feedback unit 800 may be adjacent to the display 180b.

The feedback unit 800 may be rotatably installed. The feedback unit 800 may have a plurality of rotary shafts and may rotate with respect to each of the rotary shafts.

The feedback unit 800 may include a display unit. The feedback unit 800 may rotate in response to an utterance of the occupant 910. Specifically, the feedback unit 800 may rotate such that a reference region of the feedback unit 800 faces the occupant 910 in response to the utterance of the occupant 910. Alternatively, the feedback unit 800 may change a position of the reference region and display the reference region changed in position on the display unit such that the reference region displayed on the display unit faces the occupant 910. Alternatively, the feedback unit 800 may rotate in response to the utterance of the occupant 910 such that the reference region of the feedback unit 800 faces a specified control target. Alternatively, the feedback unit 800 may change the position of the reference region and display the reference region changed in position such that the reference region displayed on the display unit faces the specified control target.

The feedback unit 800 may output a sound. When a control target is specified, the feedback unit 800 may output a sound indicating the specified control target. in a case where an additional input is necessary to control the control target, the feedback unit 800 may output a sound requesting the additional input of the occupant 910. While controlling the control target, the feedback unit 800 may output a sound indicating that control is being performed. When control of the control target is completed, the feedback unit 800 may output a sound indicating that control is completed.

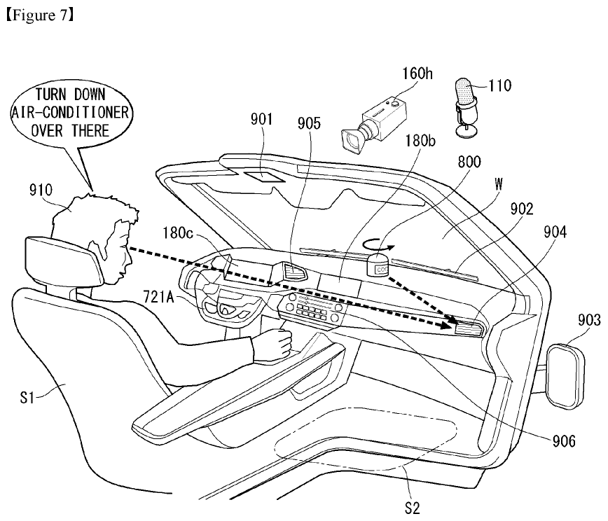

Referring to FIG. 7, the occupant 910 may look at an air vent 904 and utter “Turn down air-conditioner over there.” The processor 170 may monitor the gaze of the occupant 910 and detect that the occupant 910 is looking at the air vent 904 side. The processor 170 may receive an utterance of the occupant 910 via the microphone 170. The processor 170 may specify that a control target is the air vent 904 on the basis of the gaze and the utterance of the occupant 910. The processor 170 may control the air vent 904 such that an air volume of the air vent 904 is reduced. The feedback unit 800 may rotate toward the air vent 904. The feedback unit 800 may rotate such that the reference region thereof faces the air vent 904.

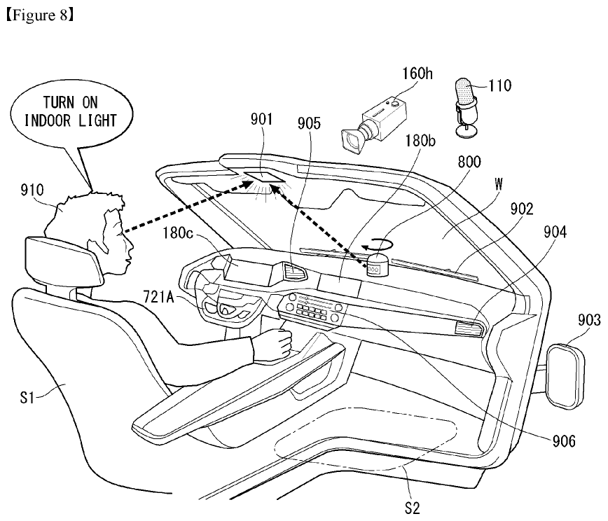

Referring to FIG. 8, the occupant 910 may look at an indoor light 901 and utter “Turn on indoor light.” The processor 170 may monitor the gaze of the occupant 910 and detect that the occupant 910 is looking at the indoor light 901 side. The processor 170 may receive an utterance of the occupant 910 via the microphone 170. The processor 170 may specify that a control target is the indoor light 901 on the basis of the gaze and the utterance of the occupant 910. The processor 170 may control the indoor light 901 to be turned on. The feedback unit 800 may rotate toward the indoor light 901. The feedback unit 800 may rotate such that the reference region thereof faces the indoor light 901.

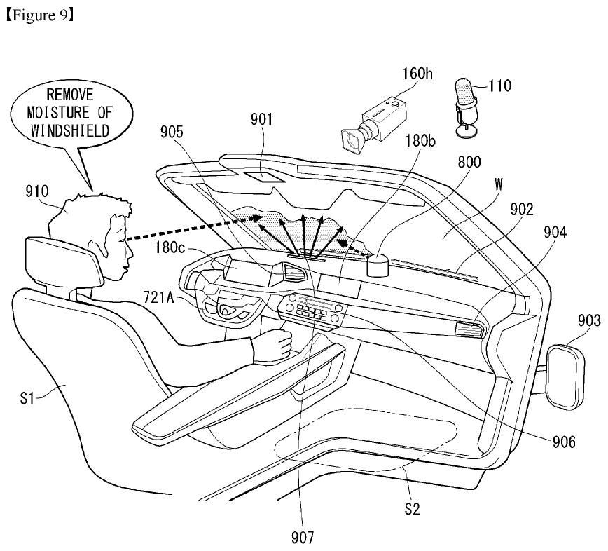

Referring to FIG. 9, the occupant 910 may look at the front windshield W and utter, “Remove moisture of windshield.” The processor 170 may monitor the gaze of the occupant 910 and detect that the occupant 910 is looking at the front windshield W side. The processor 170 may receive an utterance of the occupant 910 via the microphone 170. The processor 170 may specify that a control target is the front windshield W on the basis of the gaze and the utterance of the occupant 910. The processor 170 may control an air conditioning system 907 or an air vent 907 facing the front windshield W to be turned on so that the moisture of the front windshield W may be removed. The feedback unit 800 may rotate toward the front windshield W. The feedback unit 800 may rotate such that the reference region thereof faces the front windshield W.

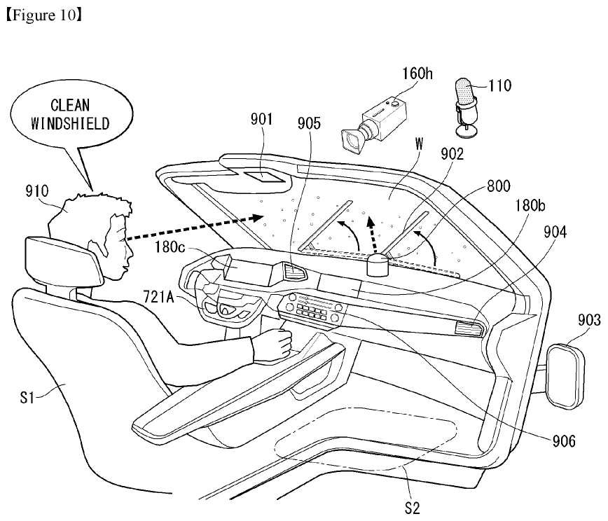

Referring to FIG. 10, the occupant 910 may look at the front windshield W and utter “Wipe windshield.” The processor 170 may monitor the gaze of the occupant 910 and detect that the occupant 910 is looking at the front windshield W side. The processor 170 may receive an utterance of the occupant 910 via the microphone 170. The processor 170 may specify that a control target is the front windshield W on the basis of the gaze and the utterance of the occupant 910. The processor 170 may control a wiper 902 to operate to remove a foreign matter of the windshield W. The feedback unit 800 may rotate toward the front windshield W. The feedback unit 800 may rotate such that the reference region thereof faces the front windshield W.

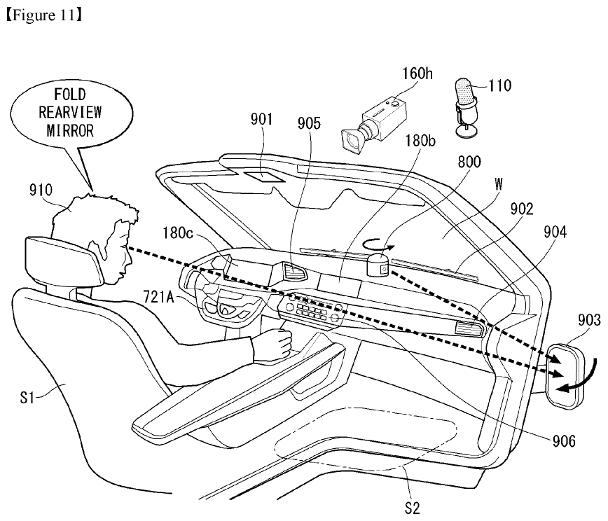

Referring to FIG. 11, the occupant 910 may look at a rearview mirror 903 and utter “Fold rearview mirror.” The processor 170 may monitor the gaze of the occupant 910 and detect that the occupant 910 is looking at a rearview mirror 903 side. The processor 170 may receive an utterance of the occupant 910 via the microphone 170. The processor 170 may specify that a control target is the rearview mirror 903 on the basis of the gaze and the utterance of the occupant 910. The processor 170 may control the rearview mirror 903 to be folded. The feedback unit 800 may rotate toward the rearview mirror 903. The feedback unit 800 may rotate such that the reference region thereof 800 faces the rearview mirror 903.

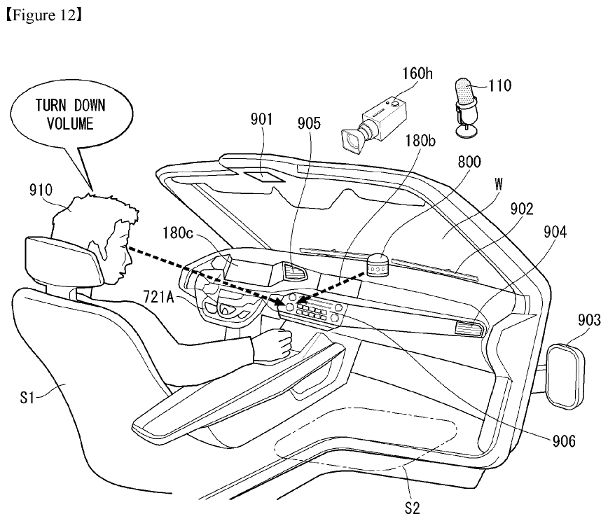

Referring to FIG. 12, the occupant 910 may look at a sound controller 906 and utter “Turn down volume.” The processor 170 may monitor the gaze of the occupant 910 and detect that the occupant 910 is looking at the sound controller 906. The processor 170 may receive an utterance of the occupant 910 via the microphone 170. The processor 170 may specify that a control target is the sound controller 906 on the basis of the gaze and the utterance of the occupant 910. The processor 170 may control the sound controller 906 to turn down a volume of a reproduced sound. The feedback unit 800 may rotate toward the sound controller 906. The feedback unit 800 may rotate such that the reference region thereof faces the sound controller 906.

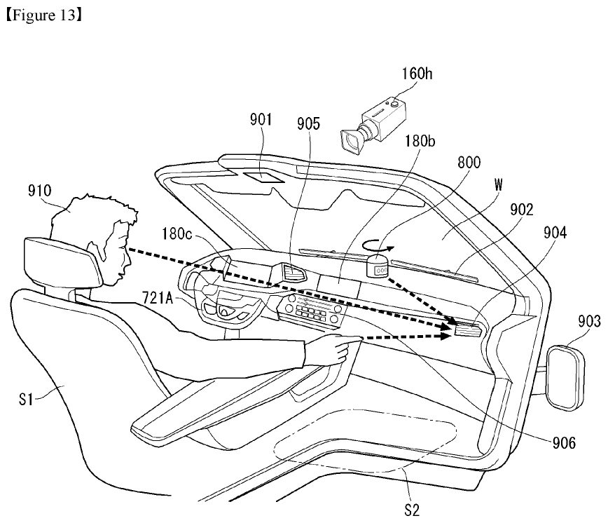

Referring to FIG. 13, the occupant 910 may look at the air vent 904 and point out the air vent 904 by hand. The processor 170 may monitor the gaze of the occupant 910 and detect that the occupant 910 is looking at the air vent 904 side. The processor 170 may monitor a body of the occupant 910 and detect pointing out the air vent 904 side. The processor 170 may specify that a control target is the air vent 904 on the basis of the gaze and the manual gesture of the occupant 910. The processor 170 may control the air vent 904 to be activated or reduce an air volume thereof. The feedback unit 800 may rotate toward the air vent 904. The feedback unit 800 may rotate such that the reference region thereof faces the air vent 904.

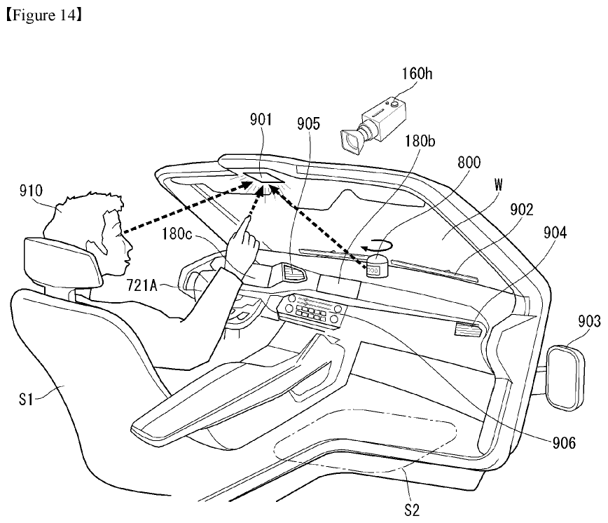

Referring to FIG. 14, the occupant 910 may look at the indoor light 901 and point out the indoor light 901 by hand. The processor 170 may monitor the gaze of the occupant 910 and detect that the occupant 910 is looking at the indoor light 901 side. The processor 170 may monitor the body of the occupant 910 to detect pointing out the air vent 904 side. The processor 170 may specify that a control target is the indoor light 901 on the basis of the gaze and the manual gesture of the occupant 910. The processor 170 may control the indoor light 901 to be turned on. Alternatively, the processor 170 may control the indoor light 901 to be turned off. The feedback unit 800 may rotate toward the indoor light 901. The feedback unit 800 may rotate such that the reference region thereof faces the indoor light 901.

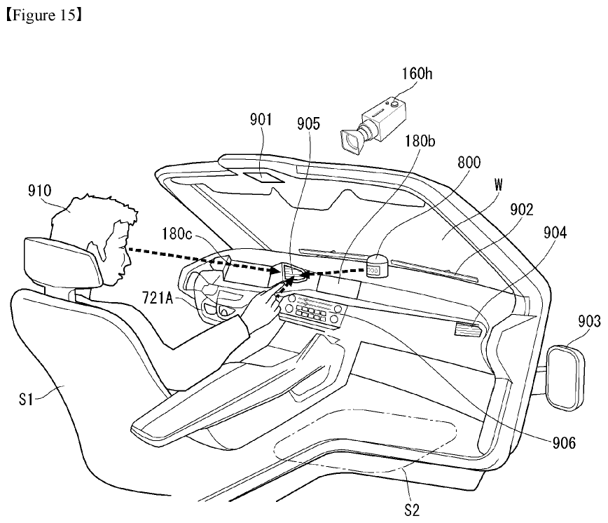

Referring to FIG. 15, the occupant 910 may look at the air vent 905 and touch the air vent 905 by hand. The processor 170 may monitor the gaze of the occupant 910 and detect that the occupant 910 is looking at the air vent 905 side. The processor 170 may monitor the body of the occupant 910 and detect that the occupant 910 touches the air vent 905. The processor 170 may specify that a control target is the air vent 905 on the basis of the gaze and the manual gesture of the occupant 910. The processor 170 may control the air vent 905 to be activated or reduce an air volume thereof. The feedback unit 800 may rotate toward the air vent 905. The feedback unit 800 may rotate such that the reference region thereof faces the air vent 905.

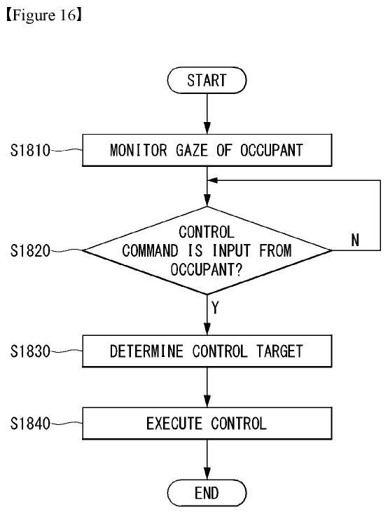

Referring to FIG. 16, the processor 170 may monitor a gaze of the occupant 910 (S1810). The processor 170 may determine whether a control command is input from the occupant 910 (S1820). The control command may be an utterance, a manual gesture, or a touch input of the occupant 910. The processor 170 may determine a control target (S1830). The processor 170 may control the determined control target (S1840).

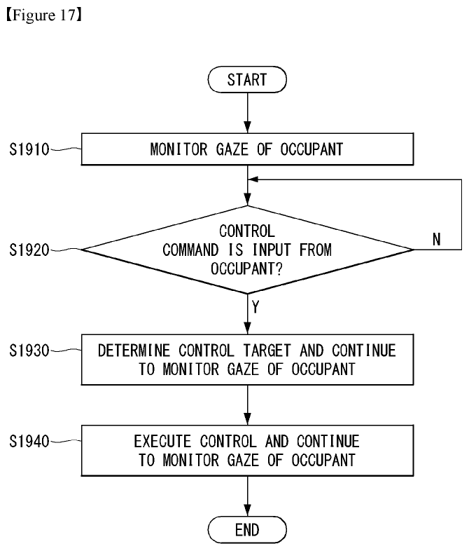

Referring to FIG. 17, the processor 170 may monitor a gaze of the occupant 910 (S1910). The processor 170 may determine whether a control command is input from the occupant 910 (S1920). The control command may be an utterance, a manual gesture, or a touch input of the occupant 910. The processor 170 may determine a control target, while continuing to monitor the gaze of the occupant 910 (S1930). The processor 170 may control the determined control target, while continuing to monitor the gaze of the occupant 910 (S1940).

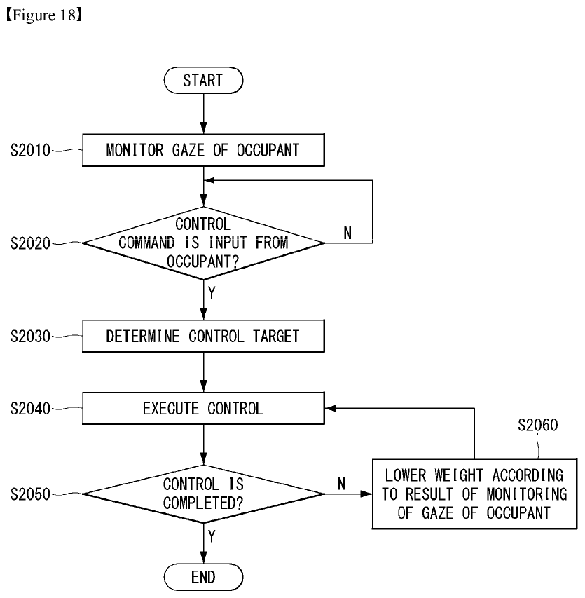

Referring to FIG. 18, the processor 170 may monitor a gaze of the occupant 910 (S2010). The processor 170 may determine whether a control command is input from the occupant 910 (S2020). The control command may be an utterance, a manual gesture, or a touch input of the occupant 910. The processor 170 may determine a control target, while continuing to monitor the gaze of the occupant 910 (S2030). The processor 170 may control the determined control target, while continuing to monitor the gaze of the occupant 910 (S2040). The processor 170 may lower a weight for a result of monitoring the gaze of the occupant 910 until the control is completed (S2050). Therefore, the processor 170 may execute the control without being affected by the result of monitoring the gaze until the control is completed.

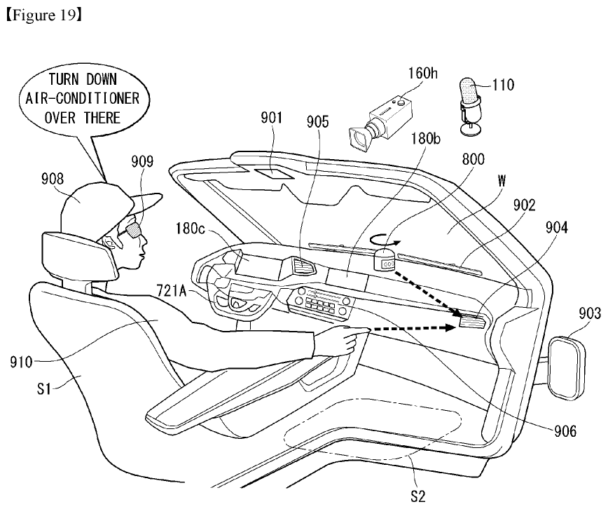

Referring to FIG. 19, the occupant 910 may look at the air vent 904, point out the air vent 904 by hand, and may utter, “Turn down air-conditioner over there.” If the occupant 910 is wearing a hat 908 or sunglasses 909, it may be difficult for the processor to monitor the gaze of the occupant. Then, the processor may not be able to specify a control target on the basis of the utterance and the gaze of the occupant. Here, the processor may monitor the body of the occupant 910 and detect that the occupant 910 points out the air vent 904 side. The processor 170 may receive the utterance of the occupant 910 via the microphone 170. The processor 170 may specify that a control target is the air vent 904 on the basis of the manual gesture and the utterance of the occupant 910. The processor 170 may control the air vent 904 to reduce an air volume thereof. The feedback unit 800 may rotate toward the air vent 904. The feedback unit 800 may rotate such that the reference region thereof faces the air vent 904.

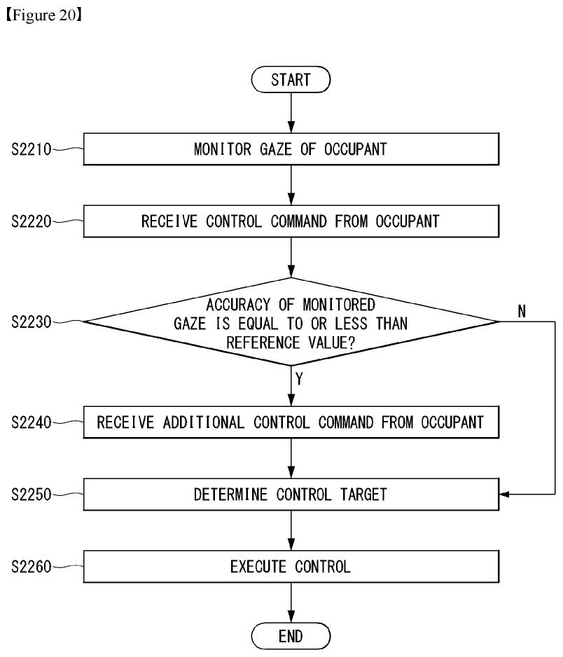

Referring to FIG. 20, the processor 170 may monitor a gaze of the occupant 910 (S2210). The processor 170 may receive a control command from the occupant 910 (S2220). The control command may be an utterance, a manual gesture, or a touch input of the occupant 910. The processor 170 may determine whether accuracy of the monitored gaze is equal to or less than a reference value. If accuracy of the monitored gaze falls below the reference value, the processor 170 cannot detect a direction of the gaze of the occupant 910. The processor 170 may receive an additional control command from the occupant 910 if the accuracy of the monitored gaze falls below the reference value (S2240). The processor 170 may specify or determine a control target on the basis of the control command and the additional control command (S2250). The processor 170 may control the determined control target (S2260).

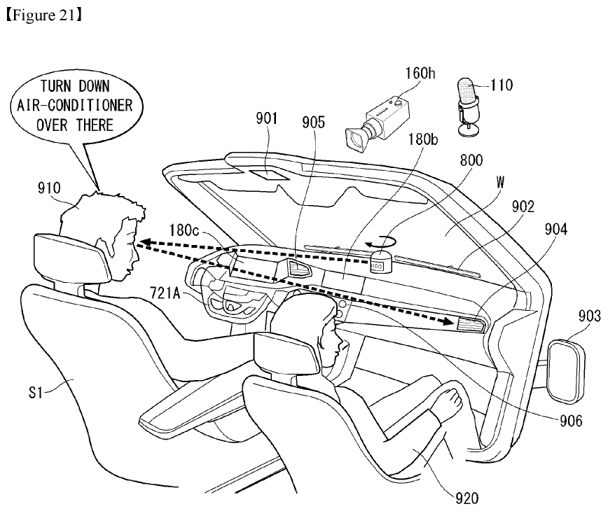

Referring to FIG. 21, a plurality of occupants 910 and 920 may be present inside the vehicle 700. The driver 910 may look at the air vent 904 and utter “Turn down air-conditioner over there.” The processor 170 may monitor a gaze of the driver 910 and detect that the occupant 910 is looking at the air vent 904 side. The processor 170 may detect which of the occupants 910 has uttered through the microphone 110 or through the microphone 110 and the camera 160h. The processor 170 may receive the utterance of the driver 910 via the microphone 170. The processor 170 may specify that a control target is the air vent 904 on the basis of the gaze and the utterance of the driver 910. The processor 170 may control the air vent 904 to reduce an air volume thereof. The feedback unit 800 may rotate toward the occupant 910 or the driver 910 who has uttered.

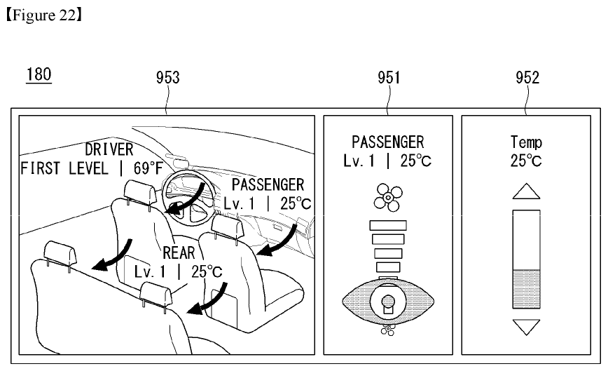

Referring to FIG. 22, the display unit 180 may display images 951, 952, and 953 to receive an input of the occupant 910. The display unit 180 may divide a display region into sections and display a plurality of images 951, 952, and 953 therein, respectively, to receive an input of the occupant 910. The occupant 910 may look at a specific image among the plurality of images 951, 952, and 953 and utter a control command. The processor 170 may determine for which of the images the occupant 910 has issued the control command on the basis of a result of monitoring a gaze of the occupant 910 and the uttered command of the occupant 910.

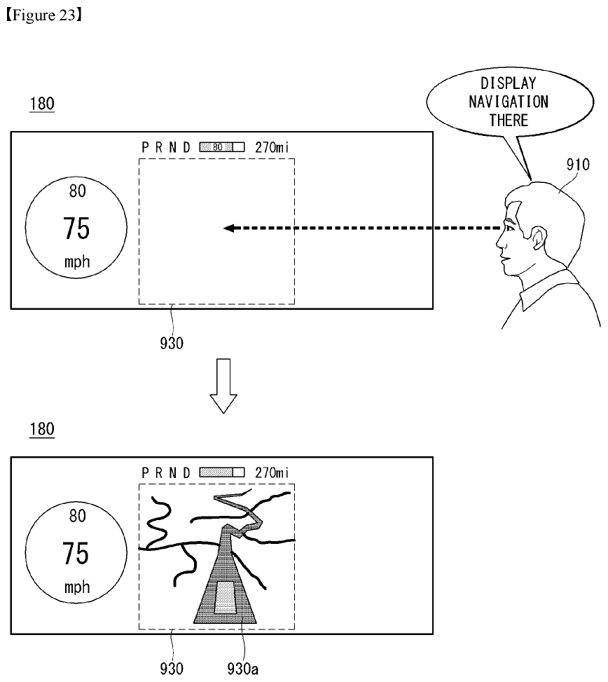

Referring to FIG. 23, the occupant 910 may look at a specific region 930 of the display unit 180 and utter “Display navigation there.” The processor 170 may monitor the gaze of the occupant 910 and detect that the occupant 910 is looking at the specific region 930. The processor 170 may receive an utterance of the occupant 910 via the microphone 170. The processor 170 may specify that a control target is the specific region 930 of the display unit 180 on the basis of the gaze and the utterance of the occupant 910. The processor 170 may control the display unit 180 to display a navigation 930a in the specific region 930.

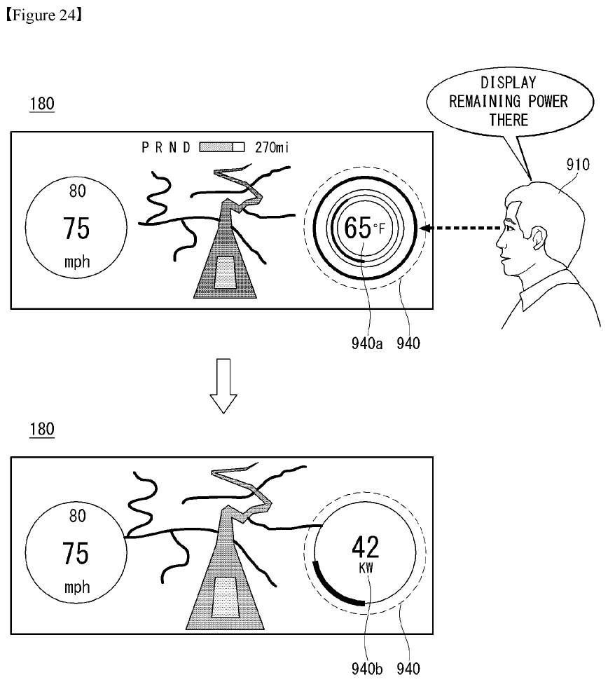

Referring to FIG. 24, the occupant 910 may look at a specific region 940 of the display unit 180 and utter “Display remaining power there.” The processor 170 may monitor the gaze of the occupant 910 and detect that the occupant 910 is looking at the specific region 940. The processor 170 may receive an utterance of the occupant 910 via the microphone 170. The processor 170 may specify that a control target is the specific region 940 of the display unit 180 on the basis of the gaze and the utterance of the occupant 910. The processor 170 may vary an image 940a for a temperature already displayed in the specific region 940 to an image 940b indicative of remaining power.

The present invention may include the following embodiments.

Embodiment 1: A control method includes: monitoring a gaze of an occupant present inside a vehicle through a camera; receiving a control command from the occupant through an input unit; determining a control target on the basis of a result of monitoring the gaze of the occupant and the control command; and controlling the control target on the basis of the control command.

Embodiment 2: The control method of Embodiment 1, in which the determining of a control target includes: searching for a plurality of control targets on the basis of the result of monitoring of the gaze of the occupant; and specifying one of the plurality of control targets on the basis of the control command from the occupant.

Embodiment 3: The control method of Embodiment 1 further includes: continuing to monitor the gaze of the occupant if the control target is determined.

Embodiment 4: The control method of Embodiment 3, in which, if the control target is determined, the control target is controlled regardless of the result of monitoring of the gaze of the occupant.

Embodiment 5: The control method of Embodiment 1, in which the input unit is a microphone installed inside the vehicle, and the control method further includes: receiving an utterance of the occupant through the microphone.

Embodiment 6: In Embodiment 5,

the control method further includes: lowering a weight of the result of monitoring of the gaze of the occupant and raising a weight of the utterance of the occupant received through the microphone if the control target is controlled on the basis of the control command.

Embodiment 6-1: The control method of Embodiment 1, in which the input unit is the camera, and the control method further includes: receiving a touch input or a gesture input of the occupant as the control command through the camera, in which the determining of the control target includes determining the control target on the basis of at least one of the touch input or the gesture input of the occupant and the result of monitoring of the gaze of the occupant.

Embodiment 7: The control method of Embodiment 1, in which the input unit includes the camera and a microphone installed in the vehicle, and the control method further includes: receiving an utterance of the occupant as a first control command through the microphone; receiving a touch input or a gesture input of the occupant as a second control command through the camera; and determining the control target on the basis of the first control command and the second control command if accuracy of the result of monitoring of the gaze of the occupant is equal to or less than a reference value.

Embodiment 8: The control method of Embodiment 1, further includes: providing feedback to the occupant through a feedback unit installed inside the vehicle and including a reference region.

Embodiment 9: The control method of Embodiment 8, further includes: rotating the feedback unit such that the reference region faces the control target when the control target is determined.

Embodiment 10: The control method of Embodiment 8, further includes: rotating the feedback unit such that the reference region faces the occupant when controlling of the control target is completed.

Embodiment 11: The control method of Embodiment 8, in which the occupant includes a first occupant and a second occupant, and the control method further includes: rotating the feedback unit such that the reference region faces the second occupant when the control command is received from the second occupant.

Embodiment 12: The control method of Embodiment 1, further includes: displaying an image related to the control target on a display unit inside the vehicle when the control target is determined.

Embodiment 13: The control method of Embodiment 1, further includes: displaying an image related to the control target on the display unit of the vehicle when the control target is controlled.

Embodiment 14: The control method of Embodiment 1, further includes: when the control target is determined as a display unit inside the vehicle and the result of monitoring of the gaze of the occupant is a first region of the display unit, displaying an image in the first region on the basis of the control command.

Embodiment 15: The control method of Embodiment 14, further includes: monitoring a gaze of the occupant, after displaying the image in the first region, to obtain a second monitoring result; receiving a second control command from the occupant; and displaying an image in a second region of the display unit on the basis of the second control command when a second control target is determined as the second region on the basis of the second monitoring result and the second control command.

Embodiment 16: The control method of Embodiment 1, further includes: providing feedback to the occupant through a sound output unit installed inside the vehicle.

Embodiment 17: A control device includes: an interface unit connected to a camera for monitoring a gaze of an occupant and an input unit receiving a control command from the occupant; and a processor exchanging information with the camera and the input unit through the interface unit, wherein the processor determines a control target on the basis of a result of monitoring the gaze of the occupant and the control command and controls the control target on the basis of the control command.

Embodiment 18: The control device of Embodiment 17, in which the processor searches for a plurality of control targets on the basis of the result of monitoring of the gaze of the occupant and specifies one of the plurality of control targets on the basis of the control command of the occupant.

Embodiment 19: The control device of Embodiment 17, in which the processor continues monitoring the gaze of the occupant if the control target is specified.

Embodiment 20: The control device of Embodiment 19, in which the processor controls the control target regardless of the result of monitoring of the gaze of the occupant, when the control target is determined.

Embodiment 21: The control device of Embodiment 17, in which the input unit is a microphone installed inside the vehicle and the processor receives an utterance of the occupant through the microphone.

Embodiment 22: The control device of Embodiment 21, in which the processor lowers a weight of the result of monitoring of the gaze of the occupant and raises a weight of the utterance of the occupant received through the microphone, when the control target is controlled on the basis of the control command.

Embodiment 23: The control device of Embodiment 17, in which the input unit is the camera, and the processor receives a touch input or a gesture input of the occupant as the control command through the camera, and determines the control target on the basis of at least one of the touch input or the gesture input of the occupant and the result of monitoring of the gaze of the occupant.

Embodiment 24: The control device of Embodiment 17, in which the input unit includes the camera and a microphone installed in the vehicle, and the process receives an utterance of the occupant as a first control command through the microphone and receives a touch input or a gesture input of the occupant as a second control command through the camera, and if accuracy of the result of monitoring of the gaze of the occupant is equal to or less than a reference value, the processor determines the control target on the basis of the first control command and the second control command.

Embodiment 25: The control device of Embodiment 17, further includes a feedback unit installed inside the vehicle and providing feedback to the occupant.

Embodiment 26: The control device of Embodiment 25, in which the feedback unit includes a reference region, and when the control target is determined, the processor rotates the feedback unit such that the reference region faces the control target.

Embodiment 27: The control device of Embodiment 25, in which the feedback unit includes a reference region, and the processor rotates the feedback unit such that the reference region faces the occupant, when control of the control target is completed.

Embodiment 28: The control device of Embodiment 25, in which the feedback unit includes a reference region, the occupant includes a first occupant and a second occupant, and when the control command is received from the second occupant, the processor rotates the feedback unit such that the reference region faces the second occupant.

Embodiment 29: The control device of Embodiment 17, in which the interface unit is connected to a display unit installed inside the vehicle, and when the control target is determined, the processor controls the display unit to display an image related to the control target.

Embodiment 30: The control device of Embodiment 17, in which the interface unit is connected to a display unit installed inside the vehicle, and when the control target is controlled, the processor controls the display unit to display an image related to the control target.

Embodiment 31: The control device of Embodiment 17, in which the interface unit is connected to a display unit installed inside the vehicle, and when the control target is displayed as the display unit inside the vehicle and a result of monitoring a gate of the occupant is a first region of the display unit, the processor displays an image in the first region on the basis of the control command.

Embodiment 32: The control device of Embodiment 31, in which the processor monitors a gaze of the occupant, after the image is displayed in the first region, to obtain a second monitoring result, and receives a second control command from the occupant through the input unit, and when a second control target is determined as a second region of the display unit on the basis of the second monitoring result and the second control command, the processor displays an image in the second region on the basis of the second control command.

The effects of the control device according to the present invention are as follows. According to at least one of the embodiments of the present invention, the control device assisting driving of a vehicle can be provided. According to at least one of the embodiments of the present invention, the control device capable of controlling inside and outside of a vehicle according to an utterance, a gaze, a manual gesture, and the like, of an occupant can be provided. According to at least one of the embodiments of the present invention, the control device capable of providing a control function suitable for each occupant when a plurality of inputs are received from a plurality of occupants can be provided.

The effects of the control method according to the present invention are as follows. According to at least one of the embodiments of the present invention, the method of assisting driving of a vehicle can be provided. According to at least one of the embodiments of the present invention, the control method of controlling inside and the outside of a vehicle according to an utterance, a gaze, a manual gesture, and the like, of an occupant can be provided. According to at least one of the embodiments of the present invention, when there is a plurality of inputs from a plurality of occupants, the control method capable of providing a control function suitable for each occupant when a plurality of inputs are received from a plurality of occupants can be provided.

The control device or the control method according to the embodiments described above may assist a driver in driving a vehicle. The control device or the control method according to the embodiments described above may assist a vehicle in performing autonomous driving or semi-autonomous driving.

The above described features, configurations, effects, and the like are included in at least one of the implementations of the present disclosure, and should not be limited to only one implementation. In addition, the features, configurations, effects, and the like as illustrated in each implementation may be implemented with regard to other implementations as they are combined with one another or modified by those skilled in the art. Thus, content related to these combinations and modifications should be construed as being included in the scope of the accompanying claims.

Further, although the implementations have been mainly described until now, they are just exemplary and do not limit the present disclosure. Thus, those skilled in the art will understand that various modifications and applications which have not been exemplified may be carried out within a range which does not deviate from the essential characteristics of the implementations. For instance, the constituent elements described in detail in the exemplary implementations may be modified to be carried out. Further, the differences related to such modifications and applications shall be construed to be included in the scope of the present disclosure specified in the attached claims.

1. A control method comprising:
monitoring a gaze of an occupant present inside a vehicle through a camera;
receiving a control command from the occupant through an input unit;
determining a control target on the basis of a result of monitoring the gaze of the occupant and the control command; and
controlling the control target on the basis of the control command.

2. The control method of claim 1, wherein
the determining of a control target comprises:
searching for a plurality of control targets on the basis of the result of monitoring of the gaze of the occupant; and
specifying one of the plurality of control targets on the basis of the control command from the occupant.

3. The control method of claim 1, further comprising:
continuing to monitor the gaze of the occupant when the control target is determined.

4. The control method of claim 3, wherein,
once the control target is determined, the control target is controlled regardless of the result of monitoring of the gaze of the occupant.

5. The control method of claim 1, wherein
the input unit is a microphone installed inside the vehicle,
wherein the control method further comprising:
receiving an utterance of the occupant through the microphone.

6. The control method of claim 5, further comprising:
lowering a weight of the result of monitoring of the gaze of the occupant and raising a weight of the utterance of the occupant received through the microphone when the control target is controlled on the basis of the control command.

7. The control method of claim 1, wherein
the input unit is the camera,
wherein the control method further comprising:
receiving a touch input or a gesture input of the occupant as the control command through the camera,
wherein the determining of a control target comprises: determining the control target on the basis of at least one of the touch input or the gesture input of the occupant and the result of monitoring of the gaze of the occupant.

8. The control method of claim 1, wherein
the input unit comprises the camera and a microphone installed in the vehicle,
wherein the control method further comprising:
receiving an utterance of the occupant as a first control command through the microphone;
receiving a touch input or a gesture input of the occupant as a second control command through the camera; and
determining the control target on the basis of the first control command and the second control command if accuracy of the result of monitoring of the gaze of the occupant is equal to or less than a reference value.

9. The control method of claim 1, further comprising:
providing feedback to the occupant through a feedback unit installed inside the vehicle and including a reference region.

10. The control method of claim 9, further comprising:
rotating the feedback unit such that the reference region faces the control target when the control target is determined.

11. The control method of claim 9, further comprising:
rotating the feedback unit such that the reference region faces the occupant when controlling of the control target is completed.

12. The control method of claim 9, wherein
the occupant comprises a first occupant and a second occupant, and
wherein the control method further comprising:
rotating the feedback unit such that the reference region faces the second occupant when the control command is received from the second occupant.

13. The control method of claim 1, further comprising:
displaying an image related to the control target on a display unit inside the vehicle when the control target is determined.

14. The control method of claim 1, further comprising:
displaying an image related to the control target on the display unit of the vehicle when the control target is controlled.

15. The control method of claim 1, further comprising:
when the control target is determined as a display unit inside the vehicle and the result of monitoring of the gaze of the occupant is a first region of the display unit, displaying an image in the first region on the basis of the control command.

16. The control method of claim 15, further comprising:
monitoring a gaze of the occupant, after displaying the image in the first region, to obtain a second monitoring result;
receiving a second control command from the occupant; and
displaying an image in a second region of the display unit on the basis of the second control command when a second control target is determined as the second region on the basis of the second monitoring result and the second control command.

17. The control method of claim 1, further comprising:
providing feedback to the occupant through a sound output unit installed inside the vehicle.

18. A control device comprising:
an interface unit connected to a camera for monitoring a gaze of an occupant and an input unit receiving a control command from the occupant; and
a processor exchanging information with the camera and the input unit through the interface unit,
wherein the processor determines a control target on the basis of a result of monitoring the gaze of the occupant and the control command and controls the control target on the basis of the control command.

19. The control device of claim 18, wherein
the processor searches for a plurality of control targets on the basis of the result of monitoring of the gaze of the occupant and specifies one of the plurality of control targets on the basis of the control command of the occupant.

20. The control device of claim 18, wherein
when the control target is specified, the processor continues monitoring the gaze of the occupant.
